(19) United States
(12) Patent Application Publication
(10) Pub. No.: US 2008/0205454 A1
(43) Pub. Date: Aug. 28, 2008

(54) Method and device for transmitting a serial data frame

(75) Inventors: Michael Riedel, Buchbach (DE); Roland Neumann, Bad Toelz (DE)

Correspondence Address: Imperium Patent Works, P.O. Box 587, Sunol, CA, 94586, US

(73) Assignee: INOVA Semiconductors GmbH

(21) Appl. No.: 11/821,660

(22) Filed: Jun. 25, 2007

(30) Foreign Application Priority Data
Feb. 23, 2007 (EP) EP 07103018.3

(51) Int. Cl. H04J 3/06

(52) U.S. Cl. 370/509

(57) ABSTRACT

A serial data frame has a payload data frame and a synchronization frame. In addition to transmitting payload data in the payload data frame, payload data is also transmitted in the synchronization frame. Special bit patterns are transmitted in the synchronization frame at predetermined times. The synchronization of the transmission of the serial data frame is performed by indicating the sequence of the bit patterns and their position in the synchronization frame to both the transmitter and the receiver of the serial data frame. Furthermore, payload data is masked using a logical operation so that a maximum permitted length of consecutive bits of the same value is avoided.

### CROSS REFERENCE TO RELATED APPLICATION

This application is based on and hereby claims the benefit under 35 U.S.C. §119 from European Application No. EP 07103018.3, filed on Feb. 23, 2007, in the European Patent Office, the contents of which are incorporated herein by reference. This application is a continuation of European Application No. EP 07103018.3.

### TECHNICAL FIELD

The present invention concerns a method and a device for transmitting a serial data frame.

### BACKGROUND

In the prior art it is known how to transmit payload data in a serial manner between a transmitter and a receiver. In such a serial transmission of payload data it is necessary, for example, to make sure that synchronization takes place between the transmitter and the receiver for the clock period used in order to recover the payload data on the receiver side. Transmission systems are desirable that reduce the bandwidth of the serial transmission of payload data. Conventional transmission systems that reduce bandwidth of a serial transmission, however, often lose some of the payload data of the serial transmission. A system is sought that prevents the loss of data while reducing the bandwidth of a data stream transmitted via a digital multimedia link.

### SUMMARY

A method and a device for transmitting a serial data frame enable the reliable transmission of the serial data frame and data contained therein.

In one embodiment, a method for transmitting a serial data frame has the steps: creating a payload data frame in which payload data are present; creating a synchronization frame in which data are transmitted and are used for synchronization; configuring the serial data frame from a previously defined sequence of the payload data frame and the synchronization frame; sending the serial data frame from a transmitting device to a receiving device; and receiving the transmitted serial data frame at the receiving device. In a plurality of consecutive serial data frames, the data used for synchronization in the synchronization frames of the serial data frames have a predetermined pattern, are sent in a predetermined sequence, and are present at a predetermined position in a particular synchronization frame of a particular serial data frame.

Synchronization frames of the consecutive serial data frames have payload data that is transmitted. Each serial data frame has a plurality of payload data frames and one synchronization frame. The predetermined pattern is chosen, depending on a predetermined rule, from a previously defined set of predetermined patterns, in order to form the predetermined sequence. The payload data frames and the synchronization frame that contain payload data to be transmitted have a flag that indicates whether the payload data being transmitted are inverted.

At least a portion of the payload data being transmitted is masked using a logical operation prior to being transmitted. The payload data frame has a flag that indicates whether or not masking has been performed on the payload data being transmitted. The masking of the payload data being transmitted is done as a function of a maximum permissible length of consecutive bits of the same value of the payload data being transmitted.

In a second embodiment of the present invention, a method for transmitting a serial data frame involves creating a payload data frame in which transmitted payload data are present. A synchronization frame is created in which transmitted data used for synchronization are present. The serial data frame is formed from a previously defined sequence of the payload data frame and the synchronization frame. The serial data frame is transmitted from a transmitting device to a receiving device. At least a portion of the payload data being transmitted is masked with a mask using a logical operation prior to being transmitted. The serial data frame has a plurality of payload data frames and one synchronization frame. The payload data frame has a flag that indicates whether or not masking was performed on the payload data being transmitted. The masking of the payload data is performed as a function of a maximum permissible length of consecutive bits of the same value of the payload data being transmitted.

In a third embodiment of the present invention, a device for transmitting a serial data frame has devices that are designed to carry out a method according to one of the aforementioned embodiments.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic block diagram of a system for sending and receiving according to an embodiment of the present invention.

FIG. 2 is a diagram showing nomenclature for a serial connection having a downlink and an uplink.

FIG. 3 is a diagram of a downlink serial data frame.

FIG. 4 is a listing of the structure of a serial data frame in extended Backus-Naur form being transmitted downlink.

FIG. 5A is a listing of the functions of the serial data-frame of FIG. 4.

FIG. 5B is a continuation of the listing of FIG. 5A of the functions of the serial data frame of FIG. 4.

FIG. 5C is a continuation of the listing of FIG. 5B of the functions of the serial data frame of FIG. 4.

FIG. 6 is a listing of the structure of a serial data frame in extended Backus-Naur form being transmitted uplink.

FIG. 7 is a listing of the functions of the serial data frame of FIG. 6.

FIG. 8 is a schematic diagram of a system for transmitting serial data frames according to an embodiment of the present invention.

### DETAILED DESCRIPTION

Reference will now be made in detail to some embodiments of the invention, examples of which are illustrated in the accompanying drawings.

A method and a device are disclosed for transmitting a serial data frame according to a sample embodiment of the present invention. The extended Backus-Naur form (EBNF) is used throughout the following description of the sample embodiment of the present invention to explain the structures of serial data frames. Moreover, the definitions of functions are explained using pseudocodes. The EBNF is expanded in this description with the symbols “<” and “>”, which are meta-symbols with special meanings and denote the start and end, respectively, of an ordered or indexed sequence of symbols. For clarity and in order to include closed base operations, function references are listed with the syntax: Designator(Parameter), where “Designator” is the name of any given function, and “Parameter” is the parameter of the function. Such functions are explicitly defined. The suffixes “ds”, “us” and “sb” used after the functions stand for “down side”, “up side”, and “side band”, respectively.

The furthest left position of an element that is part of a list, sequence or field of elements is called the highest index. More precisely, the most significant bit (MSB) is the bit at the furthest left position, and the least significant bit (LSB) is the bit at the furthest right position. In other words, the indexing starts with zero (0), and the index of the furthest right position is zero (0). A parallel/serial conversion, when required, starts with the LSB. More precisely, a bit with a lower index is sent by a transmitter and received by a receiver before any bit with a higher index.

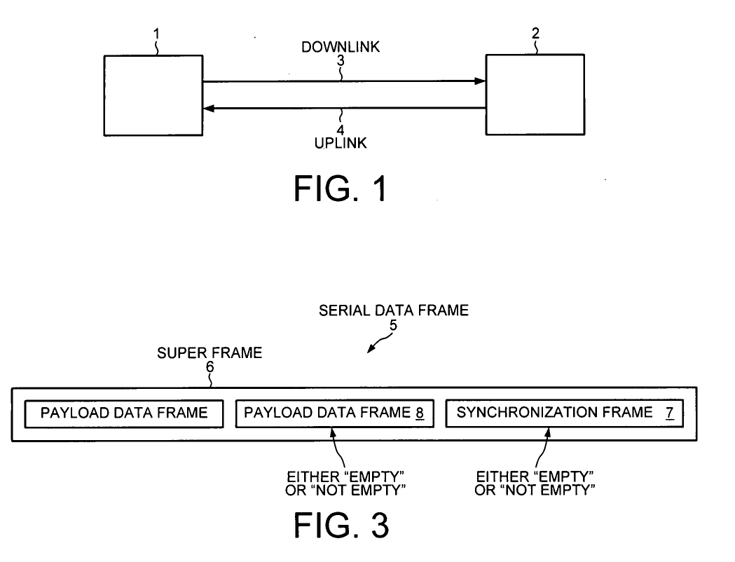

FIG. 1 is a schematic diagram of a sending/receiving system according to a sample embodiment of the present invention. The sending/receiving system of FIG. 1 has a first transmitter/receiver 1 and a second transmitter/receiver 2. Between the first transmitter/receiver 1 and the second transmitter/receiver 2, a serial downlink 3 and uplink 4 and are formed for the transmission of serial data. In this description, a link for the sending of serial data from the first transmitter/receiver 1 to the second transmitter/receiver 2 is a downlink, while a link for receiving serial data at the first transmitter/receiver 1 from the second transmitter/receiver 2 is an uplink. However, any given number of parallel and/or anti-parallel downlinks and uplinks can be present between the first transmitter/receiver 1 and the second transmitter/receiver 2. The numbers of uplinks can differ from the number of downlinks, and the number of each can be zero. Depending on the embodiment, therefore, each of the first transmitter/receiver 1 and the second transmitter/receiver 2 serves as a transmitter, a receiver, or a combination thereof.

The first transmitter/receiver 1 and the second transmitter/receiver 2 have a common, traditional makeup, and their mode of functioning is designed so as to send and/or receive the serial data frames described herein. Therefore, a more detailed explanation of the makeup of each transmitter/receiver is omitted.

The serial data transmitted between the first transmitter/receiver 1 and the second transmitter/receiver 2 are transferred using serial data frames. The serial data frames differ in the direction of the downlink and the uplink. Although only one serial data frame is described herein, generally a multiple of such serial data frames are transferred serially. These multiple serial data frames have the same makeup as that of the serial data frame described herein and are processed in an identical manner.

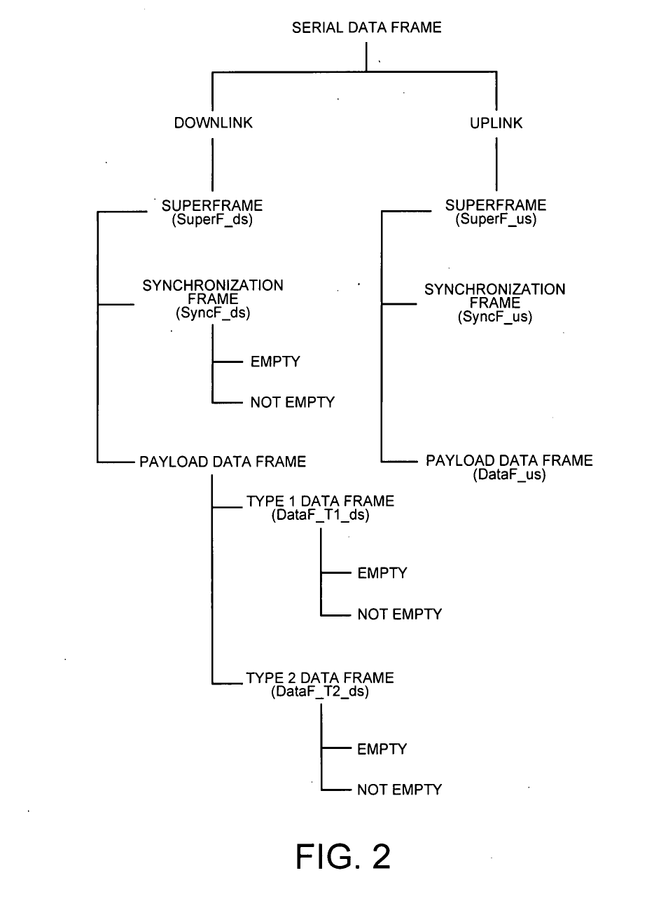

FIG. 2 shows the nomenclature of a serial connection that has a downlink and an uplink. The structure of the downlink is described first. A serial data frame of the downlink has a higher-ranking superframe “SuperF_ds”. This superframe “SuperF_ds” has a corresponding synchronization frame “SyncF_ds” and a payload data frame. The synchronization frame “SyncF_ds” can have two states, namely, “empty” and “not empty”. The payload data frame, furthermore, has a type 1 data frame “DataF_T1_ds” and a type 2 data frame “DataF_T2_ds”, both of which can have two states, either “empty” or “not empty”.

The structure of the uplink is similar. A serial data frame of the uplink has a higher-ranking superframe “SuperF_us”. This superframe “SuperF_us” furthermore has a corresponding synchronization frame “SyncF_us” and a payload data frame “DataF_us”.

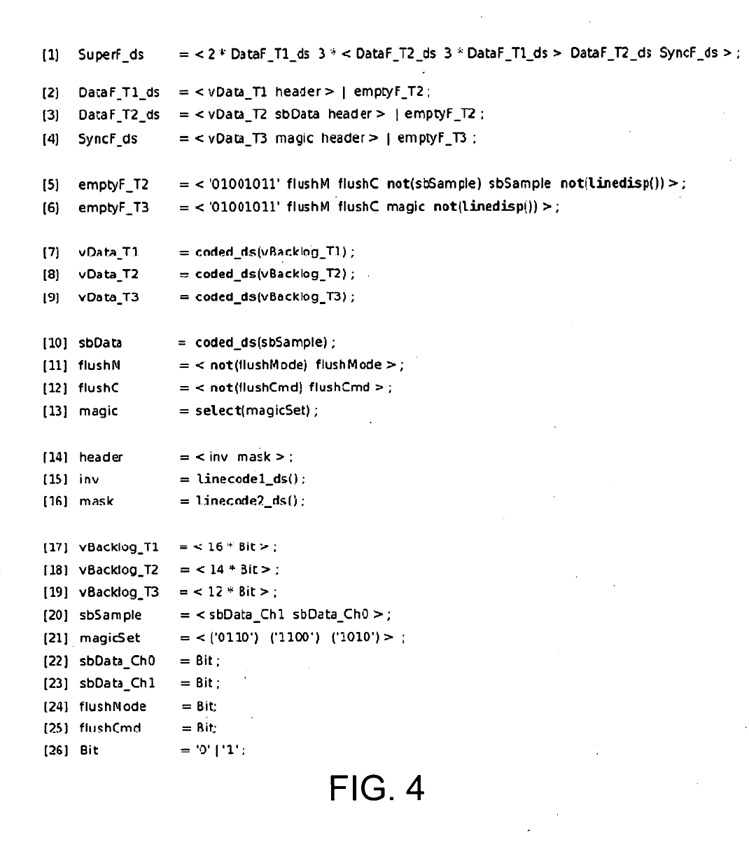

FIG. 3 is a diagram of a simple exemplary downlink serial data frame 5. FIG. 3 shows that serial data frame 5 is made up of a superframe 6 that includes a synchronization frame 7 and one or more payload data frames. A plurality of payload data frames, each of which being either type 1 or type 2, can follow synchronization frame 7. In this example, a payload data frame 8 that is a type 1 data frame follows synchronization frame 7. Each of synchronization frame 7 and the one or more payload data frames is either “empty” or “not empty”.

The structure of the serial connection is explained in more detail below using the following definitions. A frame disparity (FD) denotes the disparity or inequality of the number of “0s” and “1s” forming a serial data frame. The frame disparity (FD) is defined as the difference between the number of “0s” and the number of “1s”. A larger number of “0s” than “1s” results in a positive frame disparity (FD), an equal number of “0s” and “1s” results in a frame disparity (FD) of “0”, and a smaller number of “0s” than “1s” results in a negative frame disparity (FD).

The line disparity (LD) denotes the disparity in the number of “0s” and “1s” that have already been transmitted across the serial connection. The line disparity (LD) is defined as the difference between the number of “0s” and the number of “is”. A larger number of “0s” than “1s” results in a positive line disparity (LD), an equal number of “0s” and “is” results in a line disparity (LD) of “0”, and a smaller number of “0s” than “is” results in a negative line disparity (LD).

The number of consecutive equal bits (NCEB) is the number of consecutive bits with the same value. In other words, the number NCEB is the length of a bit vector that is an integral part of a serial data frame, wherein the bits of this vector have the same value.

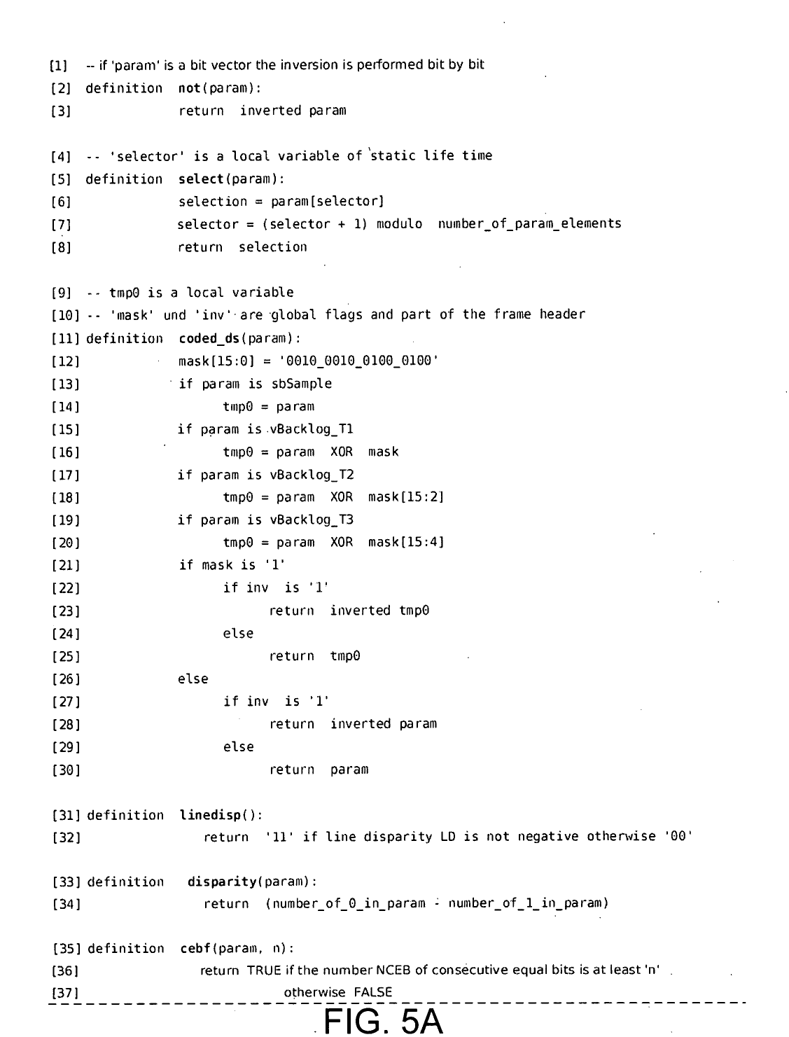

FIG. 4 shows a listing of a structure of a serial data frame transmitted downlink. The EBNF is used here to explain the structure, and definitions of functions are explained using pseudocodes. The structure is explained starting from the general layout and proceeding in more detail.

Line [1] of FIG. 4 shows that every serial superframe SuperF_ds has a sequence having two payload data frames DataF_T1_ds, followed three times by a sequence having one payload data frame DataF_T2_ds and three payload data frames DataF_T1_ds, after which there comes one payload data frame DataF_T2_ds and one synchronization frame SyncF_ds.

Line [2] of FIG. 4 shows that the payload data frame DataF_T1_ds has a sequence including (i) vData_T1 and (ii) header. Alternatively, the payload data frame DataF_T1_ds contains emptyF_T2. Line [3] shows that the payload data frame DataF_T2_ds has the sequence vData_T2, sbData and header or, instead of this sequence, it has emptyF_T2. Line [4] shows that the synchronization frame SyncF_ds has the sequence vData_T3, magic and header or, instead of this sequence, it has emptyF_T3. EmptyF_T2 is a sequence that has the bit sequence “01001011”, flushM flushC, not(sbSample), sbSample and not(linedisp( )), as shown in line [5]. EmptyF_T3 is a sequence that has the bit sequence “01001011”, flushM, flushC, magic and not(linedisp( )), as shown in line [6].

The above used vData_T1, vData_T2 and vData_T3 are defined as follows. vData_T1 is coded_ds(vBacklog_T1), vData_T2 is coded_ds(vBacklog_T2) and vData_T3 is coded_ds(vBacklog_T3), as shown in lines [7], [8] and [9]. Furthermore, the above used sbData, flushM, flushC and magic are defined as follows. sbData is coded_ds(sbSample), flushM is a sequence having not(flushMode) and flushMode, flushC is a sequence having not(flushCmd) and flushCmd, and magic is select(magicSet), as shown in lines [10], [11], [12] and [13]. Finally, header, inv and mask are defined as follows. “header” is a sequence having inv and mask, “inv” is linecode1_ds( ) and “mask” is linecode2_ds( ), as shown in lines [14], [15] and [16].

The above used vBacklog_T1, vBacklog_T2 and vBacklog_T3 are defined as follows. vBacklog_T1 is a sequence of sixteen bits, vBacklog:T2 is a sequence of fourteen bits and vBacklog_T3 is a sequence of twelve bits, as shown in lines [17], [18] and [19]. Furthermore, sbSample is a sequence having sbData_Ch1 and sbData_Ch0 and magicset is a sequence of bit groups “0110”, “1100” and “1010”, as shown in lines [20] and [21]. sbData_Ch0, sbData_Ch1, flushMode and flushCmd are each one bit with a value of either 0 or 1. This is evident in lines [22], [23], [24], [25] and [26].

One example of the make-up of the serial superframe shown in FIG. 4 is provided below. For example, a bit has a value of “0” or “1”, and vBacklog_T1 is a sequence having sixteen bits. Thus, vBacklog_T1 is entered as an input parameter into the function coded_ds( ) shown in line [10]. The output value obtained from this function with this input parameter is vData_T1, which can be part of the type 1 data frame DataF_T1_ds of the payload data frame, and moreover is part of the superframe SuperF_ds. Thus, the schematic diagram shown in FIG. 4 should be read from top to bottom as regards the direction from the general make-up of the serial superframe to the detail of the individual elements of the frame and from bottom to top for the reverse direction, as is understandable from the EBNF used.

The individual components of the uplink transferred serial superframe shall now be explained in further detail.

Empty frames are represented by emptyF_T2 and emptyF_T3, i.e., frames with no payload data that are generated by a transmitter whenever not more than sixteen bits are buffered at the transmitter for DataF_T1_ds, fourteen bits for DataF_T2_ds or twelve bits for SyncF_ds of parallel payload data as vBacklog_T1, vBacklog_T2 and vBacklog_T3, respectively.

The synchronization frame SyncF_ds denotes a special frame that carries payload data in the case of SyncF_ds=<vData_T3 magic header>, and not in the case of SyncF_ds=emptyF_T3. The synchronization frame SyncF_ds carries one of three defined bit patterns of “magic” from the set magicset having a width of four bits at bit positions [5:2] of the synchronization frame SyncF_ds. The notation [y:x] that is used here designates bit positions from the bit position x to the bit position y, while the right bit position has the lower valued bit of the two bit positions. This applies as well for the explanation below.

The synchronization frame SyncF_ds is periodically generated by the transmitter. A bit pattern “magic” from the set magicset is inserted in the serial superframe SuperF_ds that is transmitted downlink. The choice of the bit pattern “magic” is described by the following definition of the function select(param). The bit pattern “magic” is used to form and verify a frame alignment between the transmitter and a receiver.

A serial bit clock and consequently the transmission capacity of a serial transmission channel are independent of the data rate of an application that creates the payload data. In other words, it is neither the serial bit clock nor the data rate attuned to a transmission capacity that is used by an application to create payload data. When no valid payload data are present from the application, the empty frames emptyF_T2 and emptyF_T3 will be inserted into the serially transferred superframe SuperF_ds. Consequently, the receiver functions not only bit-synchronized, but also frame-synchronized, to the transmitter in order to recognize the structure of the serial superframe SuperF_ds that is being transmitted. The receiver thereby distinguishes frames with payload data from frames with filler data, i.e., frames with emptyF_T2 or emptyF_T3.

The transmitter inserts the defined bit patterns “magic” into the serial superframe SuperF_ds being transmitted so that the position of these bits in the transmitted serial superframe SuperF_ds can be used to infer the structure or frame of the transmitted serial superframe SuperF_ds. The bit patterns “magic” that are used in this process and the structure of the frame used are known both to the transmitter and the receiver. There remains a residual probability, however, that the bit pattern “magic” is also present at other positions in the serial superframe SuperF_ds being transmitted, e.g., as part of the serial payload data. When the same bit pattern is also present at other positions, synchronization between the transmitter and the receiver may be prevented or disrupted, which may lead to data loss.

Therefore, the bit patterns “magic” are not invariant or unchanging, but instead have a precisely fixed sequence that runs through a precisely defined set of all possible bit patterns “magic”. The transmitter and the receiver know (i) the set of all valid bit patterns “magic”, (ii) the order in which the bit patterns “magic” run through that set, and (iii) the interval between the various inserted bit patterns “magic”. The transmitter inserts the bit patterns “magic” equidistantly at the same interval in the transmitted serial superframe SuperF_ds. The receiver then opens a “window” at that interval and verifies the reception of the anticipated sequence of bit patterns “magic”.

Providing this information to the transmitter and receiver reduces the likelihood of a faulty synchronization between the transmitter and the receiver, especially when the periodic payload data are constant or problematical.

Moreover, this reduced likelihood shortens the time required reliably to indicate to an application that synchronization has occurred and that valid payload data are being transmitted to the receiver. Similarly, the bit patterns “magic” described above enable the transmitter and receiver of a sending/receiving system to be synchronized to each other without requiring special learning patterns when a fault is present or when the operation of the sending/receiving system begins. This means that the sending/receiving system synchronizes itself while it is operating, without any further steps.

vBacklog_T1, vBacklog_T2 and vBacklog_T3 are bit sequences with sixteen, fourteen and twelve bits, respectively, which designate the data bits to be placed in temporary storage at the transmitter. The data bits wait to be sent, using a first-in-first-out mode. At the receiver, the data bits are assembled once more into parallel data of a given size.

The transmitter generates an instruction flushCmd at its data control port at each rising signal edge. However, a falling signal edge or a level signal at the data control port can also be used for this purpose. Upon detecting a rising edge, the transmitter empties all still-buffered application data or payload data in the next serial frame DataF_T1_ds, DataF_T2_ds or SyncF_ds. The transmitter empties all data even when the transmitter has more than sixteen bits of parallel payload data buffered for DataF_T1_ds, fourteen bits for DataF_T2_ds or twelve bits for SyncF_ds as vBacklog_T1, vBacklog_T2 and vBacklog_T3, respectively. The transmitter inserts an empty frame with emptyF_T2 or emptyF_T3 so that flushCmd is used to signal the performance of an emptying process. An empty frame with emptyF_T2 or emptyF_T3 that indicates an active flushCmd tells the receiver that the payload data of the preceding (not empty) frame should be used in order to assemble parallel application data of a predefined width and discard the remaining bits. The instruction flushCmd is issued by the transmitter to force a realignment of boundaries of an application data word at the receiver.

flushMode is a bit that is a qualifier of flushCmd and is generated by the transmitter carrying out the flushCmd instruction. When active, flushMode indicates that the number of payload data bits transmitted by the preceding (not empty) frame, and to be used to reassemble application data at the receiver, is larger than a predefined width of the application data word. In other words, when flushMode is inactive, the receiver must fetch as much payload data from the preceding frame as needed to fill up the already buffered overhang vBacklog_T1, vBacklog_T2 or vBacklog_T3 and precisely reassemble a single application data word of a predefined width. Adding remaining payload data bits to the overhang vBacklog_T1, vBacklog_T2 or vBacklog_T3 of the application data is not permitted; they are discarded. When flushMode is active, the receiver must also reassemble a second application data word of a predefined width from the preceding frame before the remaining payload data bits are discarded.

sbData_Ch0 and sbData_Ch1 are sample values of sideband ports 0 and 1 of the transmitter. “inv” is a bit and part of the frame header that indicates that the entire frame, except for the two header bits, was inverted prior to the serial transmission. In this way, a dc balance or equalization of the serial superframe SuperF_ds being transmitted is made to allow an ac coupling. “mask” is a bit and part of the frame header that indicates whether a defined combinatorial mask has been applied to the payload data prior to the serial transmission, for example, by means of an exclusive-OR operation. The maximum length of consecutive bits having an identical value of “0” or “1” is limited in this way so as to ensure an upper bound on the time interval without transitions of the serial signal and so as to reduce the interference between symbols.

At each moment when a frame DataF_T1_ds, DataF_T2_ds or SyncF_ds has to be assembled at the transmitter, “inv” and “mask” of the frame header are updated and then frozen. Before a frame is finally sent to a parallel/serial converter of the transmitter, the current status of “inv” and “mask” of the frame header influences certain bit fields of the frame being assembled. “inv” and “mask” of the frame header are sent to the receiver as part of the serial frame and control the inverse transformation of the data at the receiver.

As can be seen in lines [5] and [6] of FIG. 4, emptyF_T2 and emptyF_T3 are characterized in empty frames without payload data by conditions (I), (II) and (III), as follows: (I) emptyF_T2[17:2] or emptyF_T3 is dc-balanced; (II) emptyF_T2[17:10] or emptyF_T2[17:10] is “01001011”; and (III) emptyF_T2[1:0] or emptyF_T2[1;0] is “00” or “11”. Conditions (I) and (III) together form a sufficient condition for identifying empty frames with emptyF_T2 and emptyF_T3.

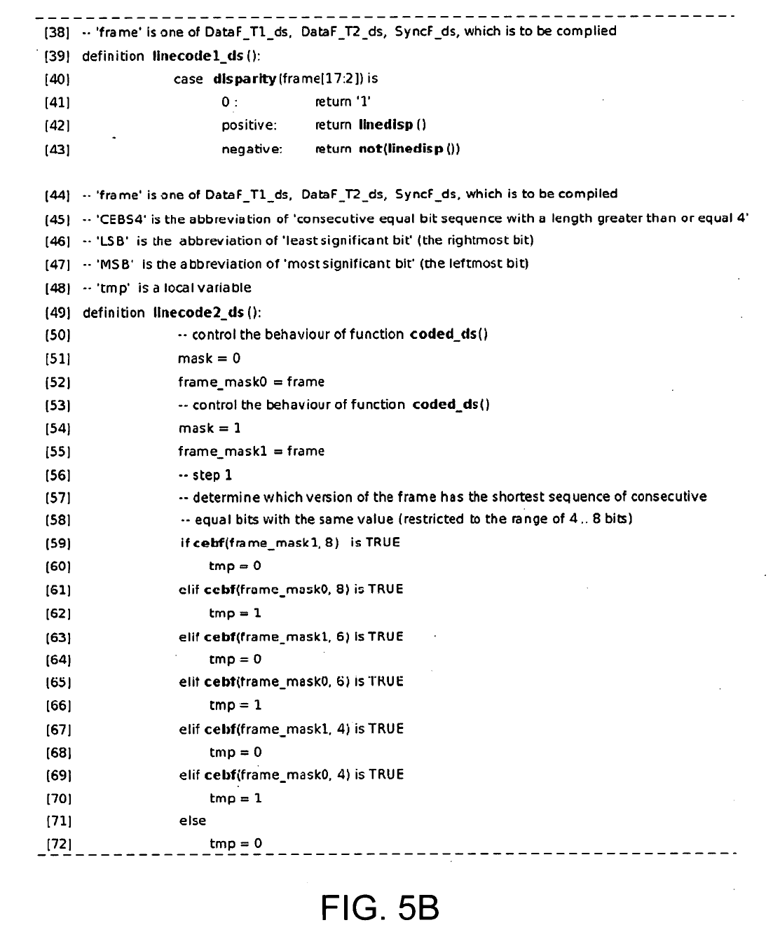

FIG. 5A shows a schematic diagram of a definition of functions in the structure shown in FIG. 4. The explanations of definitions of functions described below use pseudocode for ease of understanding. The pseudocode used for illustrative purposes, however, is not intended to be limiting. Rather, any code can be used that desigates a process or the functioning of a device so that they can generate, send and receive the serial data frame described herein, as is the case with the given pseudocode.

Lines [1] through [3] show the definition of the function “not(param)”. The function not(param) in response to the input parameter “param” returns the inverted input parameter “inverted param”. In the event that the input parameter “param” is a bit vector, the inversion is done bit by bit.

Lines [4] through [8] show the definition of the function select(param). The function select(param) in response to the input parameter param returns one of the elements of the input parameter param. In the case of magic=select(magicSet) and magicSet=<(‘0110’(‘1100’) (‘1010’)> in FIG. 4, this means that “1010” is selected assuming that the selector variable that serves as a running variable has a value “0”. Then the selector variable is increased by “1”, and the modulo of this increased selector variable forms the new variable “selector” from the number of elements of the input parameter “magicSet”. This is done to avoid resetting the selector variable after reaching the number of elements of the input parameter magicset. If, for example, the selector variable is increased from “2” to “3”, the modulo 3 of 3 will be formed, which results in “0”, so that the new selector variable is again “0”. Thus, one can proceed once more with the selection of the first element of the input parameter magicset.

Lines [9] through [30] show the definition of the function coded ds(param). As is evident from this definition, vBacklogT1, vBacklog_T2 and vBacklog_T3 are subjected to an exclusive-OR operation with a predefined mask or a defined portion thereof. Depending on the values of the “mask” and “inv” bits, an appropriate parameter will then be returned for the function coded_ds(param).

Lines [31] and [32] show the definition of the function linedisp( ). This function returns a value “11” when the above explained line disparity (LD) is not negative. Otherwise, it returns “00”.

FIG. 5B is a continuation of FIG. 5A. Lines [35] through [37] in FIG. 5A and line [38] in FIG. 5B show the definition of the function cebf(param, n). The function cebf(param, n) returns a “TRUE” value when at least the number NCEB of consecutive equal bits of the input parameter param is equal to the input parameter n. Otherwise, it returns the value “FALSE”.

Lines [39] through [43] show the definition of the function linecode1_ds( ). Depending on a value of a particular part of the return value of the function disparity(param), the function linecode1_ds( ) returns a value indicating the disparity of the particular part of the return value.

Lines [44] through [72] in FIG. 5B and lines [73] through [85] in FIG. 5C show the definition of the function linecode2_ds( ). In a step 1, the function linecode2_ds( ) determines which version of the frames DataF_T1, DataF_T2 and SyncF_ds that are being assembled has the shortest sequence of consecutive equal bits within the region of 4 . . . 8 bits. In a step 2, the function linecode2_ds( ) checks whether a long sequence of consecutive equal bits goes beyond a limit of the last already serialized frame and the current frame being made ready for sending. If so, the decision made in step 1 is altered.

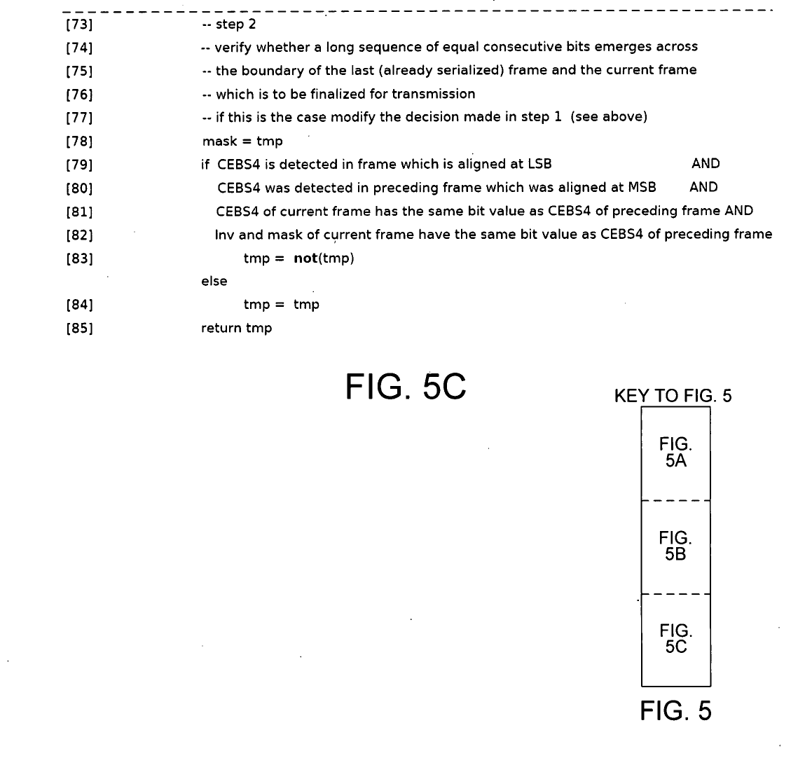

FIG. 6 is a listing of a structure of a serial data frame that is transmitted uplink. Line [1] shows that each serial superframe SuperF_us has fifteen payload data frames DataF_us and one synchronization frame SyncF_us. Line [2] shows that the payload data frame DataF_us has a sequence that includes a header and data. The header is “inv”. Lines [4] and [5] show that “inv” is linecode_us(dSample), and “data” is coded_us(dSample). Furthermore, dsample is a sequence having Data_Ch1 and Data_Ch0. Data_Ch0 and Data_Ch1 are each one bit having a value of “0” or “1”. This is evident from lines [6], [7], [8] and [11]. Line [9] shows that the synchronization frame Sync_us is select(magicSet). Line [10] shows that “magicSet” is a sequence of bit groups “110”, “101”, “100”, “011”, “010” and “001”.

The individual components of the serial superframe that is transmitted uplink are explained in greater detail below. The synchronization frame SyncF_us designates a special frame carrying no payload data, but having one of six defined bit patterns from the set magicSet in a width of three bits. The synchronization frame SyncF_us is periodically generated by the receiver. The choice of a bit pattern from the set magicSet, which is to be inserted into the uplink transferred serial superframe SuperF_us, is described by the following definition of the function select(param). The bit pattern is needed to form and verify a frame alignment between the receiver and the transmitter. Lines [7] and [8] indicate that data_Ch0 and data_Ch1 are sample values of data ports 0 and 1 of the receiver. “inv” is a bit and constitutes the frame header. “inv” indicates that the entire frame, except for the frame header, was inverted prior to the serial transmission. “inv” can be used to indicate that a dc balance is carried out for the serial superframe SuperF_us being transmitted, which enables an ac coupling.

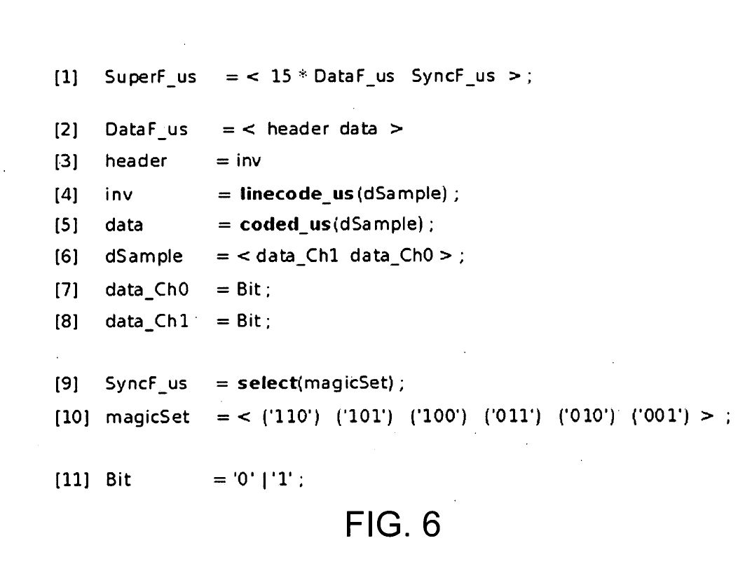

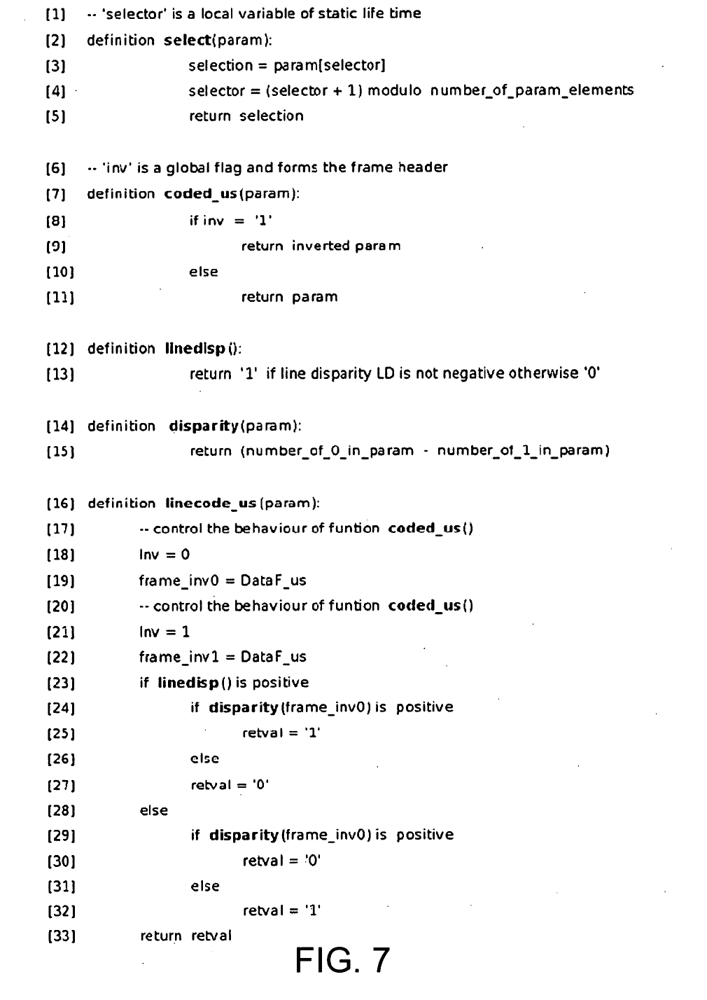

FIG. 7 is a listing of a definition of functions in the structure shown in FIG. 6. The functions defined in FIG. 7 with the same or similar designations as in FIGS. 5A through 5C result in the same or similar actions. Thus, a detailed explanation of these functions is omitted here.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method for transmitting consecutive serial data frames, comprising:
generating a payload data frame that contains payload data;
generating a synchronization frame that contains data used for synchronization;
configuring a first serial data frame from a predetermined sequence of the payload data frame and the synchronization frame; and
transmitting the first serial data frame from a transmitting device to a receiving device, wherein the data used for the synchronization have a predetermined pattern, are transmitted in a predetermined sequence, and are present at a predetermined position in the synchronization frame of the first serial data frame, and wherein data used for synchronization in a second serial data frame have the same predetermined pattern, are transmitted in the same predetermined sequence, and are present at the same predetermined position in the synchronization frame of the second serial data frame as in the first serial data frame.

2. The system of claim 1, wherein payload data is transmitted in synchronization frames of the consecutive serial data frames.

3. The system of claim 1, wherein the first serial data frame includes a single synchronization frame and a plurality of payload data frames.

4. The system of claim 1, wherein the predetermined pattern is determined based on a predefined set of predetermined patterns, and wherein the predetermined pattern is used to generate the predetermined sequence.

5. The system of claim 1, wherein the synchronization frame contains payload data, and wherein each of the synchronization frame and the payload data frame includes a flag that indicates whether the payload data are inverted.

6. The system of claim 1, wherein at least part of the payload data is masked using a logical operation prior to the transmitting.

7. The system of claim 6, wherein the payload data frame has a flag that indicates whether the payload data has been masked.

8. The system of claim 6, wherein the payload data is masked based on a maximum permitted length of consecutive bits of equal value in the payload data.

9. A method for transmitting a serial data frame, comprising:
generating a payload data frame that contains payload data;
generating a synchronization frame that contains data used for synchronization;
generating the serial data frame using a predetermined sequence of the payload data frame and the synchronization frame; and
transmitting the serial data frame from a transmitting device to a receiving device, wherein at least a portion of the payload data is masked using a logical operation prior to the transmitting.

10. The method of claim 9, wherein the serial data frame includes a single synchronization frame and a plurality of payload data frames.

11. The method of claim 9, wherein the payload data frame has a flag that indicates that the payload data has been masked.

12. The method of claim 9, wherein the payload data is masked based on a maximum permitted length of consecutive bits of equal value in the payload data.

13. A system comprising:
a receiver that receives a transmission of a serial data frame, wherein the serial data frame includes a payload data frame and a synchronization frame, wherein the synchronization frame contains data used for synchronization, and wherein the data used for synchronization are transmitted in a predetermined sequence of bit patterns and are present at a predetermined position in the synchronization frame; and
means for synchronizing the transmission of the serial data frame by indicating the predetermined sequence of bit patterns and their predetermined position in the synchronization frame to both the receiver of the serial data frame and to the means.

14. The system of claim 13, wherein the serial data frame includes a single synchronization frame and a plurality of payload data frames.

15. The system of claim 13, wherein the payload data frame contains payload data, and wherein at least a portion of the payload data is masked using a logical operation prior to the transmission of the serial data frame.

16. The system of claim 15, wherein the payload data frame includes a flag that indicates whether the payload data are inverted.

17. The system of claim 15, wherein the logical operation is an exclusive-OR operation.

18. The system of claim 15, wherein the payload data are masked based on a maximum permitted length of consecutive bits of equal value in the payload data.

19. The system of claim 18, wherein the payload data frame has a flag that indicates that the payload data have been masked.

20. The system of claim 13, wherein the data used for synchronization have a predetermined bit pattern.
